(19) United States
(12) Patent Application Publication
(10) Pub. No.: US 2024/0109400 A1
(43) Pub. Date: Apr. 4, 2024

(54) A REINFORCEMENT MEMBER FOR A VEHICLE

(71) Applicant: TATA STEEL LIMITED, Jharkhand (IN)

(72) Inventors: Shashank CHOUDHARY, Jharkhand (IN); Rahul Kumar VERMA, Jharkhand (IN); Pala LAKSHMIKANT, Jharkhand (IN); Suman GUHA, Jharkhand (IN); Manikandan G, Jharkhand (IN); Dipan SUTARIA, Jharkhand (IN); Sudhakar Ramamoorthy MARUR, Jharkhand (IN)

(21) Appl. No.: 18/273,251

(22) PCT Filed: Jan. 19, 2022
(86) PCT No.: PCT/IB2022/050414

§ 371 Date: Jul. 19, 2023

(30) Foreign Application Priority Data
Jan. 20, 2021 (IN) 202131002770

(51) Int. Cl. B60J 5/04

(52) U.S. Cl. CPC B60J 5/0443; B60J 5/0484

(57) ABSTRACT

Present disclosure discloses a reinforcement member (10) for a vehicle. The member includes a first component (1) made of steel and a second component (2) secured to a portion of the first component. The second component is made of a reinforced polymer. The reinforcement member with the combination of the second component and the first component is configured to absorb impact energy. The reinforcement member (10) of the present disclosure is lighter in weight unlike the conventional reinforcement members and is structured to absorb/attenuate significantly impact higher energy than the conventional beams.

### TECHNICAL FIELD

Present disclosure relates to field of automobiles. Particularly, but not exclusively, the present disclosure relates components for absorbing impact energy in vehicles. Further embodiments of the present disclosure disclose a configuration of reinforcement member for absorbing impact energy during side collision of the vehicle.

### BACKGROUND OF THE DISCLOSURE

Vehicles are generally constructed to include various support structures for the engine, wheels, suspension, bumper, doors, and other related components. These support structures may include members that are generally aligned with the longitudinal axis of the vehicle, that run in a generally transverse direction relative to the longitudinal members or at oblique angles to these axes. The support structures surrounding and supporting the engine compartment may be ultimately connected to various structures that define the vehicle cabin. These cabin support structures may generally include vertical door hinge pillar, the A-pillar that extends from the door hinge pillar to the roof of the vehicle, a laterally extending cross beam, a floor pan running across the width of the vehicle, and a rocker member extending rearwardly from the bottom of the hinge pillar.

The support structures mentioned above provide support for various vehicle components, as well as exterior structures, that are mounted thereto. Examples of vehicle components include the engine, transmission, radiator, suspension, wheels, and the like. Examples of exterior structures include the doors, roof, windshield, floor panels, hood, and the like. In addition to providing support for the various vehicle parts, the support structure also operates to protect the vehicle occupants in the event of a collision, such as a frontal impact collision, rearward collision, collision from sides, oblique collision, and the like.

With the continuing attempts to improve passenger safety in vehicles, impact beams have been developed for use in various portions of the vehicle for example in the side doors. Typically, the beams include structural steel members which extend between the fore and aft within vertically extending walls of the vehicle door. Conventionally, these structural steel members have been made from sheet metal into various cross-sectional configurations, most commonly a hat-shaped cross-section. Straight tubular beams with various end attachments are also used as structural steel members. Despite striving for improved impact absorption, weight and cost consideration are also important to maintain the efficiency and economy of the vehicle.

Furthermore, vehicle safety standards specify that impact beams must meet certain load or energy absorbing criteria for a specified lateral displacement of the components in vehicle. Such standards include displacement of door in response to a vehicle being subjected to the side impact. While known side door impact beam assemblies used in vehicles have been satisfactory in use and have met these safety standards, there is a continuing effort to reduce the weight and/or cost of these assemblies without sacrificing protection or energy-absorption of these impact beam assemblies. In addition to the hat-shaped and straight tubular beam configuration most commonly used in vehicles, various configurations have been experimented to improve the side impact beam. Changes to the hat-section and straight tubular shapes have not been commonly used because of the cost and difficulty of manufacturing.

The present disclosure is directed to overcome one or more limitations stated above or any other limitations associated with the prior arts.

The information disclosed in this background of the disclosure section is only for enhancement of understanding of the general background of the invention and should not be taken as an acknowledgement or any form of suggestion that this information forms the prior art already known to a person skilled in the art.

### SUMMARY OF THE DISCLOSURE

One or more shortcomings of the conventional assemblies are overcome by an assembly and a method as claimed and additional advantages are provided through the provision of assembly and the method as claimed in the present disclosure.

Additional features and advantages are realized through the techniques of the present disclosure. Other embodiments and aspects of the disclosure are described in detail herein and are considered a part of the claimed disclosure.

In one non-limiting embodiment of the disclosure, a reinforcement member for a vehicle is disclosed. The member includes a first component made of steel and a second component secured to a portion of the first component. The second component is made of a reinforced polymer. The reinforcement member with the combination of the second component and the first component is configured to absorbs impact energy.

In an embodiment of the disclosure, the steel is a hot stamped boron steel. The hot stamped boron steel is a 22MnB5 grade boron steel. In another embodiment of the invention, the steel is advanced high strength steel selected from a group of Advanced High Strength Steel like DP 780, DP 980, or Complex phase steels with suitable formability.

In an embodiment of the disclosure, the reinforced polymer is at least one of glass fibre reinforced polymer and carbon fibre reinforced polymer. The reinforced polymer is moulded by orienting fibres in a pre-defined orientation. The pre-defined orientation of fibres is one of 0/0 orientation, 0/90 orientation, 30/−30 orientation, 90/90 orientation and 60/−60 orientation.

In an embodiment, the second component is secured at a substantially central portion of the first component. The second component is secured to the first component covering area ranging from 60% to 90% of the first component. The second component is secured to the portion of the first component through a bonding process.

In an embodiment of the disclosure, the first component is defined with flanges on either end. The flanges are configured to secure the first component to a portion of the vehicle.

In an embodiment of the disclosure, the reinforcement member is a door intrusion beam of the vehicle.

In an embodiment of the disclosure, the profile of the first component complements the profile of the second component. The profile of the first component and the second component is corrugated profile.

In another non-limiting embodiment, a method of manufacturing a reinforcement member is disclosed. The method includes securing a first component made of steel of pre-determined dimensions to a second component made of reinforced polymer through a bonding process.

In yet another non-limiting embodiment of the disclosure, a vehicle door is disclosed. The vehicle door includes an inner panel, an outer panel connectable to the inner panel such that the inner panel and the outer panel defining a door well there between. The vehicle door includes a door intrusion beam connectable to at least one of the inner panel and the outer panel and extending into the door well. The door intrusion beam includes a first component made of steel and a second component secured to a portion of the first component. The second component is made of a reinforced polymer. The door intrusion beam with the combination of the second component and the first component is configured to absorb impact energy.

It is to be understood that the aspects and embodiments of the disclosure described above may be used in any combination with each other. Several of the aspects and embodiments may be combined to form a further embodiment of the disclosure.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING FIGURES

The novel features and characteristic of the disclosure are set forth in the appended claims. The disclosure itself, however, as well as a preferred mode of use, further objectives, and advantages thereof, will best be understood by reference to the following detailed description of an illustrative embodiment when read in conjunction with the accompanying figures. One or more embodiments are now described, by way of example only, with reference to the accompanying figures wherein like reference numerals represent like elements and in which:

FIG. 1 illustrates a perspective view of a vehicle door illustrating a reinforcement member, in accordance with an embodiment of the present disclosure.

FIG. 2 illustrates an exemplary schematic view of the reinforcement member of FIG. 1, in accordance with an embodiment of the present disclosure.

FIG. 3 illustrates an exemplary view of the reinforcement member of FIG. 2 subject to analysis using an impactor.

FIG. 4 illustrates an exemplary view of the reinforcement member deformed upon subjecting to analysis using the impactor of FIG. 3.

The figures depict embodiments of the disclosure for purposes of illustration only. One skilled in the art will readily recognize from the following description that alternative embodiments of the structures and methods illustrated herein may be employed without departing from the principles of the disclosure described herein.

### DETAILED DESCRIPTION

The foregoing has broadly outlined the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiments disclosed may be readily utilized as a basis for modifying or designing other structures for carrying out the same purposes of the present disclosure. It should also be realized by those skilled in the art that such equivalent processes do not depart from the spirit and scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure. It will be readily understood that the aspects of the present disclosure, as generally described herein, and illustrated in the figures, can be arranged, substituted, combined, and designed in a wide variety of different configurations, all of which are explicitly contemplated and make part of this disclosure.

Embodiments of the present disclosure discloses a structural (also referred to as reinforcement member in the present disclosure) member for use in vehicles. The structural member may be used to reinforce crucial zones of the vehicle for improving occupant safety in the vehicle. The crucial zones in the vehicles may include front-end and rear-end (also known as crumple zone) and side portions (including doors) of the vehicle. The reinforcement member may be configured to absorb/attenuate impact energy in event of crash. Also, the reinforcement member of the present disclosure may be manufactured in accordance with the federal motor vehicle safety standard (FMVSS). For example, the structural member may be manufactured such that it satisfies/outperforms the guidelines laid down in the FMVSS number 214. Unlike the conventional reinforcement members, the structural member of the present disclosure may be lighter in weight. Since, the structural member is lighter in weight, overall weight of the vehicle reduces, thereby ensuring better efficiency. Also, the impact absorption/attenuation of the reinforcement member of the present disclosure may be significantly higher unlike the conventional reinforcement structures.

In an embodiment, the reinforcement member of the present disclosure may be configured to attenuate the crash energy and increase occupant safety. The reinforcement member of the present disclosure may include a first component made of steel. In an embodiment, the steel may be formed into a pre-defined structure using metal forming process such as hot stamping process. Steel used in the present disclosure may be hot stamped boron steel of grade 22MnB5. In another embodiment, the steel used may be advanced high strength steel [AHSS] such as but not limiting to DP780 steel and DP980 steel (DP-dual phase). Further, the first component may be of corrugated shape, and ends of the first component may be defined with flanges. The flanges may aid in securing the first component to a portion of the vehicle body. The reinforcement member may further include a second component secured to a portion of the first component. The second component may be made of materials such as a reinforced polymer. The second component of the present disclosure may be made of glass fiber reinforced polymers. In an embodiment, the second component may also be made of carbon fiber reinforced polymers. The second component may be secured to the first component by bonding process. Such that, the combination of the first component and the second component may be configured to attenuate/absorb crash energy in event of vehicle undergoing collision.

The terms “comprises . . . a”, “comprising”, or any other variations thereof used in the specification, are intended to cover a non-exclusive inclusion, such that an assembly that comprises a list of components or steps does not include only those components or steps but may include other components or steps not expressly listed or inherent to such setup or method. In other words, one or more elements in an assembly proceeded by “comprises . . . a” does not, without more constraints, preclude the existence of other elements or additional elements in the assembly.

Henceforth, the present disclosure is explained with the help of one or more figures of exemplary embodiments. However, such exemplary embodiments should not be construed as limitation of the present disclosure.

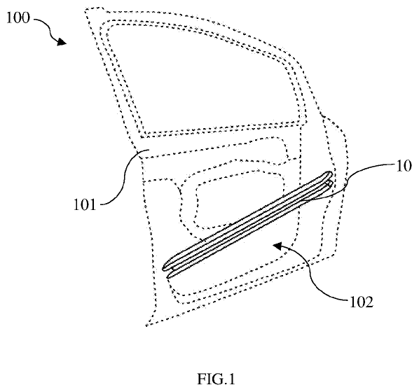

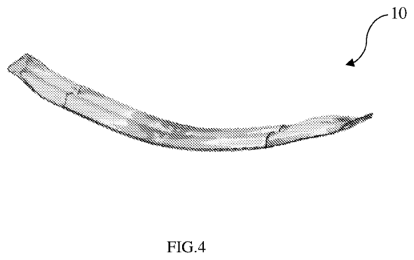

The following paragraphs describe the present disclosure with reference to FIGS. 1 and 3. In the figures, the same element or elements having similar functions are indicated by the same reference signs. For the purpose of promoting an understanding of the principles of the disclosure, reference will now be made to specific embodiments illustrated in the drawings and specific language will be used to describe the same. It will nevertheless be understood that no limitation of the scope of the invention is thereby intended, such alterations and further modifications in the illustrated methods, and such further applications of the principles of the invention as illustrated therein being contemplated as would normally occur to one skilled in the art to which the invention pertains.

The following detailed description is merely exemplary in nature and is not intended to limit application and uses. Furthermore, there is no intention to be bound by any theory presented in the preceding background or summary or the following detailed description. It is to be understood that the disclosure may assume various alternative orientations and step sequences, except where expressly specified to the contrary. It is also to be understood that the specific devices or components illustrated in the attached drawings and described in the following specification are simply exemplary embodiments of the inventive concepts defined in the appended claims. Hence, specific dimensions or other physical characteristics relating to the embodiments that may be disclosed are not to be considered as limiting, unless the claims expressly state otherwise. Hereinafter, preferred embodiments of the present disclosure will be described referring to the accompanying drawings. While some specific terms of “upper,” “lower,” “right,” or “left”, “vertical” or “horizontal” and other terms containing these specific terms and directed to a specific orientation of the assembly as shown in figures and the purpose of usage of these terms or words is merely to facilitate understanding of the present disclosure referring to the drawings. Accordingly, it should be noted that the meanings of these terms or words should not improperly limit the technical scope of the present disclosure.

A representative reinforcement [also alternatively referred to as structural member] member [as shown in FIG. 1] embodying the concepts of the present disclosure is designated generally by the numeral (10) in the accompanying drawings. The following description may be described with respect to a door (100) of the vehicle employing the reinforcement member (10) [hereinafter also referred to as door intrusion beam (10)]. However, the same should not be construed as a limitation of the present disclosure as a person skilled in the art could employ the same to reinforce other crucial and non-crucial zones in the vehicle. Further, in the figures door of a passenger vehicle has been shown for the purpose of explanation and simplicity. However, the same should not be construed as a limitation, since the same can be employed in doors of any vehicle including passenger vehicle, commercial vehicles, and the like.

Referring to FIG. 1, there is shown vehicle door (100) adapted to be hingedly mounted to a vehicle body. The vehicle door (100) [hereinafter referred to as door (100)] includes an outer panel [not shown], an inner panel (101), and metal front wall and rear end wall to which the outer and inner panel (101) are joined by a thermal joining process such as welding. In an embodiment, the inner panel (101) and the outer panel may be made of metallic materials. The outer panel, the inner panel (101) and the end walls define a door well (102) therebetween. In order to structurally reinforce the door (100) against side impacts, the reinforcement member (10) may be mounted substantially horizontally within the door well (102) and secured to the end walls to form a protective impediment across the door (100). The reinforcement member may be also referred to as a side impact door intrusion beam (10), designed to absorb the impact energy acting on the vehicle door (100). In accordance with the present disclosure, the door intrusion beam (10) provides a reduction of weight in the door assembly and a reduction of manufacturing costs through the use of less expensive materials while maintaining vehicle safety standards.

The door intrusion beam (10) of the present disclosure generally includes a first component (1) having a predetermined cross-sectional configuration and flanges (3) secured to or integrally formed with either ends of the first component (1). The flanges (3) facilitate attachment of the reinforcement beam (10) to the door (100). Specifically, the flanges (3) are thermally or mechanically joined to the end walls of the door (100) such that the reinforcement member (10) extends substantially horizontally across the door well (102) [as shown in FIG. 1].

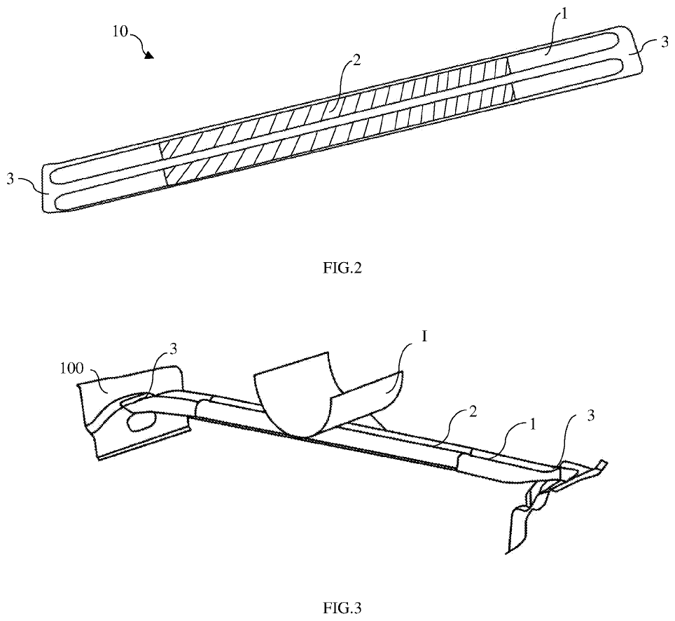

The first component (1) [as shown in FIG. 2] of the reinforcement member (10) may be made of steel. The steel used in manufacturing of the first component (1) may be advanced high strength steel [AHSS] or hot-stamped boron steel. In an embodiment, the AHSS may be at least one of DP780 steel, DP980 steel and the like. In preferred embodiment of the disclosure, the steel used in manufacturing the first component (1) may be hot stamped boron steel. The hot stamped boron steel used in the manufacturing of the first component (1) may be of 22MnB5 grade. In an embodiment, shape of the first component (1) may be corrugated. In another embodiment, shape of the first component (1) may resemble M-shape. However, shape of the first component (1) should not be construed as a limitation of the present disclosure and any modification to the shape of first component (1) will form a part of the present disclosure.

Further, the reinforcement member (10) may include a second component (2). The second component (2) may be secured to a portion of the first component (1). In an embodiment, the second component (2) may be secured to the first component (1) by bonding process but not limiting to the same. The adhesive used in the bonding process may be industrial grade adhesive such as but not limiting betamate 2096. Any such adhesives may also be used in the bonding process and the above described or illustrated adhesive should not be construed as a limitation of the present disclosure. In an embodiment, the second component (2) may be secured to the first component (1) at a substantially central portion. In some embodiments, the first component (1) and the second component (2) may be stacked in pre-determined order to achieve desired results. The second component (2) may cover 60% to 90% of the first component (1). In an embodiment, shape of the second component (2) complements the shape of the first component (1). The shape of the second component (2) may also be corrugated.

The second component (2) may be made of a reinforced polymer. In a preferred embodiment, the reinforced polymer used in the present disclosure may be a glass fiber reinforced polymer [GFRP]. In some embodiments, the second component (2) may be made of carbon fiber reinforced polymer [CFRP]. The material for manufacturing the second component (2) of the reinforcement member (10) and the combination of first component (1) and second component (2) thereof is shown in Table-1. In an embodiment, the reinforced polymers [i.e., GFRP and CFRP] may be moulded by orienting fibers (i.e., glass fibers/carbon fibers) in a pre-defined orientation. In some embodiments, the moulding methods include but not limiting to thermoset moulding or vacuum infusion process. The pre-defined orientation of the fibers may significantly alter the energy absorption of the reinforcement member (10). The various orientation of fibers and the combination thereof may be provided in Table-2 of the present disclosure. The pre-defined orientation of fibers for moulding the reinforced polymers include 0/0 orientation, 0/90 orientation, 30/−30 orientation, 90/90 orientation and 60/−60 orientation.

In a preferred embodiment, the first component (1) made of hot stamped boron steel and the second component (2) made of glass fiber reinforced polymer [GFRP] may be configured as the reinforcement member (10), to attenuate/absorb impact energy in the event of collision of the vehicle. The combination of the first component (1) and the second component (2) meets the guidelines under FMVSS 214.

Hereinafter, an exemplary experimental analysis of the reinforcement member (10) may be illustrated for better understanding of the present disclosure.

### Exemplary Experimental Analysis

Following paragraphs may be illustrate exemplary experimental results illustrating a test set-up to test the reinforcement member (10) and energy absorption of the reinforcement member (10). Referring to FIG. 3, which illustrates the test set up for testing the energy absorption efficiency of the reinforcement member (10) of the present disclosure. The first component (1) of thickness 0.7 mm along with the second component (2) of thickness 2.64 mm is bonded together to form the reinforcement member (10) for analysis of energy absorption. Cropped ends of the door ends are considered in simulation where the reinforcement member (10) is fixed as shown in FIG. 3. An impactor (I) of radius 100 mm and length 200 mm is made to strike the reinforcement member (10) with a velocity of 55 km/hr. As shown in FIG. 4, the reinforcement member (10) may undergo deformation upon striking by the impactor. In the FIG. 4, the load distribution in the reinforcement member (10) may be illustrated by way of simulation when subjected to striking by the impactor (I). The force and displacement of the reinforcement member (10) has been measured, and energy absorption is calculated. To optimize the energy absorption and reduce weight of the reinforcement member various combinations of first component (1) and the second component (2) thereof were analyzed [as shown in Table-2]. For example, the combination of first component (1) and the second component (2) for the reinforcement member may include a combination of hot stamped boron steel and GFRP. The energy absorption of the said combination for the reinforcement member (10) would increase by 16.6% to 1.45 kJ and reduce the weight by 12% to 1.174 Kg when compared to reinforcement member completely made of hot stamped boron steel.

TABLE 1
Analysis of combination of first component and second component

| | | | | Energy | |
|---|---|---|---|---|---|
| | | | | Absorption (kJ) | Weight (kg) |
| | | | | (change w.r.t | (change w.r.t |
| | | | | Hot Stamped | Hot Stamped |
| Sl. | | | Thickness | 22MnB5 grade of | 22MnB5 grade of |
| No | Material | Combination | (mm) | Boron steel) | Boron steel) |
| 1 | Complete part using | None | 1.2 | 1.25 (Base) | 1.34 (Base) |
| | Hot Stamped 22MnB5 | | | | |
| | Boron Steel | | | | |
| 2 | Complete part using DP | None | 1.2 | 0.94 (less | 1.34 (No |
| | 780 | | | by 25%) | change) |
| 3 | Part using DP 780 and | DP780-GFRP | 0.7-2.3 | 1.35 (More | 1.34 (No |
| | GFRP (GFRP on | | | by 8%) | change) |
| | complete part) | | | | |
| 4 | Part using DP 780 and | DP780-GFRP | 0.7-2.64 | 1.36 (More | 1.174 (Less |
| | GFRP (600 mm in the | | | by 8.8%) | by 12%) |
| | centre) | | | | |
| 5 | Part using DP 780 and | DP780-CFRP | 0.7-1.375 | 1.39 (More | 0.96 (less |
| | CFRP (600 mm in the | | | by 11.2%) | by 29%) |
| | centre) | | | | |
| 6 | Part using DP 780 and | GFRP-DP780- | 1.32-0.7- | 1.06 (15.2% | 1.17 (less |
| | GFRP (600 mm in the | GFRP | 1.32 | less) | by 12%) |
| | centre) | | | | |
| 7 | Part Using DP780 and | DP780-GFRP- | 0.7-0.99- | 1.65 (32% | 1.56 (16% |
| | GFRP (600 mm in the | DP780-GFRP | 0.7-0.99 | more) | more) |
| | centre) | | | | |
| 8 | Part Using DP980 and | DP980-GFRP | 0.7-2.31 | 1.28 (2% | 1.13 (less |
| | GFRP (600 mm in the | | | more) | by 16%) |
| | centre) | | | | |
| 9 | Part Using DP980 and | DP980-CFRP | 0.7-1.250 | 1.27 (1.6% | 0.94 (less |
| | CFRP (600 mm in the | | | more) | by 30%) |
| | centre) | | | | |
| 10 | Part Using DP980 and | GFRP-DP980- | 1.32-0.7- | 1.02 (18.4% | 1.13 (less |
| | GFRP (600 mm in the | GFRP | 0.99 | less) | by 16%) |
| | centre) | | | | |
| 11 | Part Using DP980 and | DP980-GFRP- | 0.7-0.99- | 1.8 (44% | 1.51 (12.6% |
| | GFRP (600 mm in the | DP980-GFRP | 0.7-0.66 | more) | more) |
| | centre) | | | | |
| 12 | Part using Hot Stamped | Boron steel- | 0.7-2.64 | 1.45 (More | 1.174 (Less |
| | 22MnB5 grade of | GFRP | | by 16.6%) | by 12%) |
| | boron steel and GFRP | | | | |
| | (600 mm in the centre) | | | | |
| 13 | Part Using Hot Stamped | Boron steel- | 0.7-1.250 | 1.31 (4.8% | 0.94 (less |
| | 22MnB5 grade of | CFRP | | more) | by 30%) |
| | boron steel and CFRP | | | | |
| | (600 mm in the centre) | | | | |

The Table-1 illustrates comparison of results of simulation study with various combination of first component (1) and the second component (2). As can be seen from the Table-1, securing the entire portion of the first component (1) with the second component (2) may increase energy absorption but does not aid in reduction of weight. On the contrary, securing only the portion of the first component (1) with the second component (2) significantly increases the energy absorption and ensure that the weight of combination of the first component (1) and the second component (2) may be lesser (by about 12%). Table also shows the energy absorption with various first and second component (1 and 2) combination such Steel-GFRP, GFRP-steel-GFRP and steel-GFRP-steel-GFRP combination which can be used to manufacture the beam. Similar results with lesser thickness may also be achieved using CFRP-Steel combination.

TABLE 2
Analysis of orientation of fibres in the second component

| | | | | Thick- | Energy |
|---|---|---|---|---|---|
| Sl | | Combi- | Orien- | ness | Absorption |
| No | Material | nation | tation | (mm) | (kJ) |
| 1 | Part using DP 780 | DP780- | 0/0 | 0.7-2.64 | 1.36 |
| | and GFRP (GFRP on | GFRP | | | |
| | complete part) | | | | |
| 2 | Part using DP 780 | DP780- | 0/90 | 0.7-2.64 | 1.18 |
| | and GFRP (GFRP on | GFRP | | | |
| | complete part) | | | | |
| 3 | Part using DP 780 | DP780- | 30/−30 | 0.7-2.64 | 1.13 |
| | and GFRP (GFRP on | GFRP | | | |
| | complete part) | | | | |
| 4 | Part using DP 780 | DP780- | 90/90 | 0.7-2.64 | 0.88 |
| | and GFRP (GFRP on | GFRP | | | |
| | complete part) | | | | |
| 5 | Part using DP 780 | DP780- | 60/−60 | 0.7-2.64 | 0.86 |
| | and GFRP (GFRP on | GFRP | | | |
| | complete part) | | | | |

TABLE 3
Analysis of orientation of fibres with Hot Stamped Boron Steel

| | | | | Thick- | Energy |
|---|---|---|---|---|---|
| Sl | | Combi- | Orien- | ness | Absorption |
| No | Material | nation | tation | (mm) | (kJ) |
| 1 | Part Using Hot | Boron | 0/0 | 0.7-2.64 | 1.46 |
| | Stamped 22MnB5 | steel- | | | |
| | grade of boron steel | GFRP | | | |
| | and GFRP | | | | |
| | (600 mm in the centre) | | | | |
| 2 | Part Using Hot | Boron | 0/90 | 0.7-2.64 | 1.44 |
| | Stamped 22MnB5 | steel- | | | |
| | grade of boron steel | GFRP | | | |
| | and GFRP | | | | |
| | (600 mm in the centre) | | | | |
| 3 | Part Using Hot | Boron | 30/−30 | 0.7-2.64 | 1.41 |
| | Stamped 22MnB5 | steel- | | | |
| | grade of boron steel | GFRP | | | |
| | and GFRP | | | | |
| | (600 mm in the centre) | | | | |
| 4 | Part Using Hot | Boron | 90/90 | 0.7-2.64 | 1.15 |
| | Stamped 22MnB5 | steel- | | | |
| | grade of boron steel | GFRP | | | |
| | and GFRP | | | | |
| | (600 mm in the centre) | | | | |
| 5 | Part Using Hot | Boron | 60/−60 | 0.7-2.64 | 1.14 |
| | Stamped 22MnB5 | steel- | | | |
| | grade of boron steel | GFRP | | | |
| | and GFRP | | | | |
| | (600 mm in the centre) | | | | |

The effect of orientation of fibres in moulding of reinforced polymer to form the second component (2) may be illustrated in Table-2 and Table-3. Table-2 depicts analysis of orientation of fibres in second component (2) with DP780 steel as first component (1) and Table-3 depicts analysis of orientation of fibres in second component (2) with hot stamped boron steel as first component (1). The orientation of fibres significantly affects the energy absorption of the reinforcement beam (10). Therefore, orientation of fibres which enable optimum energy absorption may be selected to form the second component (2). As can be seen from Table-2 and Table-3, 0/0 (longitudinal) orientation shows the maximum energy absorption during the bending and 60/−60 orientation shows the minimum energy absorption.

The reinforcement member (10) of the present disclosure may be lighter in weight unlike the conventional reinforcement members. In an embodiment, the reinforcement member (10) may be configured to absorb/attenuate significantly higher energy than the conventional system. Advantageously, the overall weight of the vehicle may be reduced by employing reinforcement member (10) of the present disclosure without compromising on safety of occupants.

It is to be understood that a person of ordinary skill in the art may develop assembly of similar configuration without deviating from the scope of the present disclosure. Such modifications and variations may be made without departing from the scope of the present disclosure. Therefore, it is intended that the present disclosure covers such modifications and variations provided they come within the ambit of the appended claims and their equivalents.

### EQUIVALENTS

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding the description may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated in the description.

### REFERRAL NUMERALS

| Description | Reference number |
|---|---|
| Reinforcement member | 10 |
| First member | 1 |
| Second member | 2 |
| Flanges | 3 |
| Door | 100 |
| Inner panel | 101 |
| Impactor | I |

1. A reinforcement member (10) for a vehicle, the member (10) comprising:
a first component (1) made of steel; and
a second component (2) secured to a portion of the first component (1), wherein the second component (2) is made of a reinforced polymer,
wherein, the reinforcement member (10) with the combination of the second component (2) and the first component (1) is configured to absorb impact energy.

2. The member (10) as claimed in claim 1, wherein the steel is hot stamped boron steel.

3. The member (10) as claimed in claim 2, wherein the hot stamped boron steel is a 22MnB5 grade boron steel.

4. The member (10) as claimed in claim 1, wherein the steel is advanced high strength steel [AHSS] selected from a group comprising of DP780 steel and DP980 steel.

5. The member (10) as claimed in claim 1, wherein the reinforced polymer is at least one of glass fiber reinforced polymer [GFRP] and carbon fiber reinforced polymer [CFRP].

6. The member (10) as claimed in claim 1, wherein the reinforced polymer is moulded by orienting fibers in a pre-defined orientation.

7. The member (10) as claimed in claim 6, wherein the pre-defined orientation is at least one of 0/0 orientation, 0/90 orientation, 30/−30 orientation, 90/90 orientation and 60/−60 orientation.

8. The member (10) as claimed in claim 1, wherein the second component (2) is secured at a substantially central portion of the first component (1).

9. The assembly (10) as claimed in claim 1, wherein the second component (2) is secured to the first component (1) covering area ranging from 60% to 90% of the first component (1).

10. The member (10) as claimed in claim 1, wherein the second component (2) is secured to the portion of the first component (1) through bonding process.

11. The member (10) as claimed in claim 1, wherein the first component (1) is defined with flanges (3) on either end, the flanges (3) are configured to secure the first component (1) to a portion of the vehicle.

12. The member (10) as claimed in claim 1, wherein the reinforcement member (10) is a door intrusion beam of the vehicle.

13. The member (10) as claimed in claim 1, wherein the profile of the first component (1) complements the profile of the second component (2).

14. The member (10) as claimed in claim 1, wherein the profile of the first component (1) and the second component (2) is corrugated profile.

15. A method of manufacturing a structural reinforcement member (10) of claim 1, the method comprises:
securing a first component (1) made of steel of pre-determined dimensions to a second component (2) of reinforced polymer through a bonding process.

16. The method as claimed in claim 15, wherein the steel is an advanced high strength steel [AHSS] selected from a group comprising of boron steel, DP780 steel and DP980 steel.

17. The method as claimed in claim 15, wherein the steel is hot stamped boron steel.

18. The method as claimed in claim 17, wherein the hot stamped boron steel is a 22MnB5 grade boron steel.

19. The method as claimed in claim 15, wherein the reinforced polymer is at least one of glass fiber reinforced polymer [GFRP] and carbon fiber reinforced polymer [CFRP].

20. The method as claimed in claim 15, wherein reinforced polymers is moulded by orienting fibers in a pre-defined orientation.

21. The method as claimed in claim 20, wherein the pre-defined orientation is at least one of 0/0 orientation, 0/90 orientation, 30/−30 orientation, 90/90 orientation and 60/−60 orientation.

22. A vehicle door (100) comprising:
an inner panel (101);
an outer panel connectable to the inner panel (101) such that the inner panel (101) and the outer panel define a door well (102) therebetween; and
a door intrusion beam (10) connectable to at least one of the inner panel (101) and outer panel and extending into the door well (102), the door intrusion beam (10) comprises:
a first component (1) made of steel; and
a second component (2) secured to a portion of the first component (1),
wherein the second component (2) is made of a reinforced polymer,
wherein, the door intrusion beam (10) with the combination of the second component (2) and the first component (1) is configured to absorb impact energy.

23. The vehicle door (100) as claimed in claim 22, wherein the reinforced polymer is at least one of glass fiber reinforced polymer [GFRP] and carbon fiber reinforced polymer [CFRP].

24. The vehicle door (100) as claimed in claim 22, wherein the steel is hot stamped boron steel.

25. The vehicle door (100) as claimed in claim 24, wherein the hot stamped boron steel is a 22MnB5 grade boron steel.

26. The vehicle door (100) as claimed in claim 22, wherein the steel is advanced high strength steel [AHSS] selected from a group comprising of DP780 steel and DP980 steel.
